(19) United States
(12) Patent Application Publication
(10) Pub. No.: US 2005/0243746 A1
(43) Pub. Date: Nov. 3, 2005

(54) Session inspection scheme

(75) Inventors: Jari Mutikainen, Helsinki (FI); Arto Leppisaari, Kangasala (FI); Juha Kallio, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/910,516

(22) Filed: Aug. 3, 2004

(30) Foreign Application Priority Data
Apr. 29, 2004 (EP) 04 010 233.7

(51) Int. Cl. H04L 12/28

(52) U.S. Cl. 370/282; 370/410

(57) ABSTRACT

The present invention relates to a method and system for inspecting a session in a packet data network, wherein a set-up message is selectively routed to a predetermined server node (4001, 4002) and processed there. A media resource function (3021, 3022) is controlled based on the processing so as to bind incoming and outgoing data streams in order to relay the session via the media resource function. Thereby, a mechanism for providing charging, filtering and logging services for sessions, such as peer-to-peer chat sessions, is provided without requiring any new network entity or modification of existing network specifications.

### FIELD OF THE INVENTION

The present invention relates to a method and system for inspecting a session in a packet data network, and particularly to an application server and a media resource function processor to be used in such an inspection system.

### BACKGROUND OF THE INVENTION

Third generation mobile networks will exploit high transmission speeds to provide complex multimedia services. It is to that purpose that a particular subsystem, named IMS (Internet Protocol Multimedia Subsystem) has been introduced to enable standardized and controlled multimedia services at low costs. The new so-called All IP network environment can be divided into a core network and an access network. The core network can be divided into separate subsystems comprising a circuit switched (CS) core network subsystem, which consists of all core network entities which provide CS services, a packet switched (PS) core network subsystem which consists of all core network entities which provide PS connectivity services, a services subsystem which consists of all entities providing capabilities to support operators specific services, and the IMS which consists of all core network elements for providing IP multimedia and telephony services.

In particular, the IMS provides IP-based telephony and multimedia sessions on top of radio access network (RAN) and PS domains. Service and session control of subscribed services for roaming subscribers is in the home network. The Session Initiation Protocol (SIP) which is used for session control is an application-layer control signaling protocol for creating, modifying, and terminating sessions with one or more participants.

In IMS a chat session is established using SIP and SDP (Service Description Protocol). Chat is just another media that is negotiated using an SDP offer/answer model. Once the SIP session has been established, the actual chat messages are transported using MSRP (Message Session Relay Protocol). MSRP is a new protocol that is currently under development in IETF (Internet Engineering Task Force).

For service providers it would be advantageous if the IMS network was able to charge, log, and filter peer-to-peer chat sessions based on number of messages, content types in a message, and size of the messages. The current Release 6 architecture is not able to provide such functionalities. This means that the network must include an entity which is in the path of peer-to-peer messages, interprets chat messages, and generates charging information accordingly. In the known proposals, this functionality was implemented in a new session messaging functionality entity. However, this approach leads to the drawback that the same entity is controlling the conference, i.e. acting as a conference application server. Hence, this proposal would lead to a duplication of existing functionalities in the network environment.

According to another approach, a relay functionality of the Message Session Relay protocol (MSRP) as described in the Internet draft “draft-ietf-simple-message-sessions-02” was proposed, according to which a predetermined MSRP message (BIND) is to be sent before SIP session establishment to thereby provide the required MSRP relay function. This proposal leads to new requirements in the IMS network and thus to substantial modifications of the existing specifications due to the fact that the Packet Data Protocol (PDP) context for media needs to be opened before the use of media has been authorized. Another drawback associated with such MSRP relays is that this functionality is not supported by the IETF (Internet Engineering Task Force).

### SUMMARY OF THE INVENTION

It is therefore an object of the present invention to provide a method and system for inspecting sessions in a packet data network, by means of which new entities or relay functions are not necessary and which does not require context opening before media authorization.

This object is achieved by a method of inspecting a session in a packet data network, said method comprising the steps of:
selectively routing a set-up message of said session to a predetermined server node of said packet data network;
processing said set-up message at said server node; and
controlling a media resource function of said packet data network based on said processing step so as to bind incoming and outgoing data streams in order to relay said session via said media resource function.

Furthermore, the above object is achieved by a system for inspecting a session in a packet data network, said system comprising:
routing means for selectively routing a set-up message of said session to a predetermined server node of said packet data network, said server node being configured to process said set-up message; and
media resource function means for binding incoming and outgoing data streams in order relay said session via said media resource function means, said media resource function means being controlled by said server node based on said processing of said set-up message.

Additionally, the above object is achieved by an application server for providing information required by a remote or local application of a packet data network, said application server being configured to receive and process a set-up message of a session of said packet data network, and to control a media resource function of said packet data network to bind incoming and outgoing data streams in order to inspect said session at said media resource function.

Finally, the above object is achieved by a media resource function processor node for establishing data bearers to support mixed media streams, said processor node being configured to bind incoming and outgoing data streams in order to relay sessions via said processor node in response to a control signaling and to initiate an inspection of said session.

Accordingly, existing functionalities of the network architecture can be used for inspecting sessions, e.g. chat sessions, to provide charging, filtering and logging services for sessions in packet data networks, such as the IMS network environment. In particular, a Back-To-Back User functionality is provided where session set-up messages can be received and processed so as to provide a relay function required for inspecting the session, e.g., obtaining charging data.

The routing step may be performed in response to a predetermined filter criteria set for the inspection. Thereby, network operators can provide the inspection function for charging, logging or filtering the sessions in an individual and selective manner.

The session may be an instant session according to the MSRP. Then, binding may be performed using at least one of a context identity, a session identity, a termination identity and an address of the MRSP, e.g. a MRSP Uniform Resource Locator (URL). In particular, an address information which contains a session identification may be returned from the media resource function to the predetermined server node. This address information may be returned in a reserved local descriptor for terminal side termination. The address information may then be forwarded by the predetermined server node to a terminating network side in a session invitation message, and the address information may be used at the terminating network side to address the media resource function.

As an example, the set-up message may be a SIP Invite method.

Furthermore, a charging record may be generated for said relayed session at said media resource function. In particular, an interface may be provided between the media resource function and a charging collection function to generate charging data for the relate session. As an alternative, the server node may be notified of the receipt of a predetermined message of the session, and a charging record may be generated at the server node based on the notification.

The controlling may be performed using a H.248 signaling. In particular, the controlling may comprise reserving a context and termination at the media resource function, and offering a remote descriptor of the termination. Additionally, the controlling step may comprise setting a local descriptor to a value indicating that it can be selected by a media resource function.

Additionally, permitted content types of the session may be limited at the media resource function.

The routing means may comprise an IMS Call Session Control Function. The media resource function means may comprise an IMS Media Resource Function Processor and Media Resource Function Controller. Additionally, the media resource function means may comprise an interface to a charging collection function. The server node may be an application server for providing application-related information.

Further advantageous modifications are defined in the dependent claims.

### BRIEF DESCRIPTION OF THE DRAWINGS

In the following, the present invention will be described in greater detail based on a preferred embodiment with reference to the accompanying drawings in which:

FIG. 1 shows a schematic block diagram of a network architecture supporting multimedia sessions, in which the present invention can be implemented; and

FIG. 2 shows a schematic block diagram of a network architecture with a corresponding signaling scheme for providing a session inspection functionality according to the preferred embodiment.

### DESCRIPTION OF THE PREFERRED EMBODIMENT

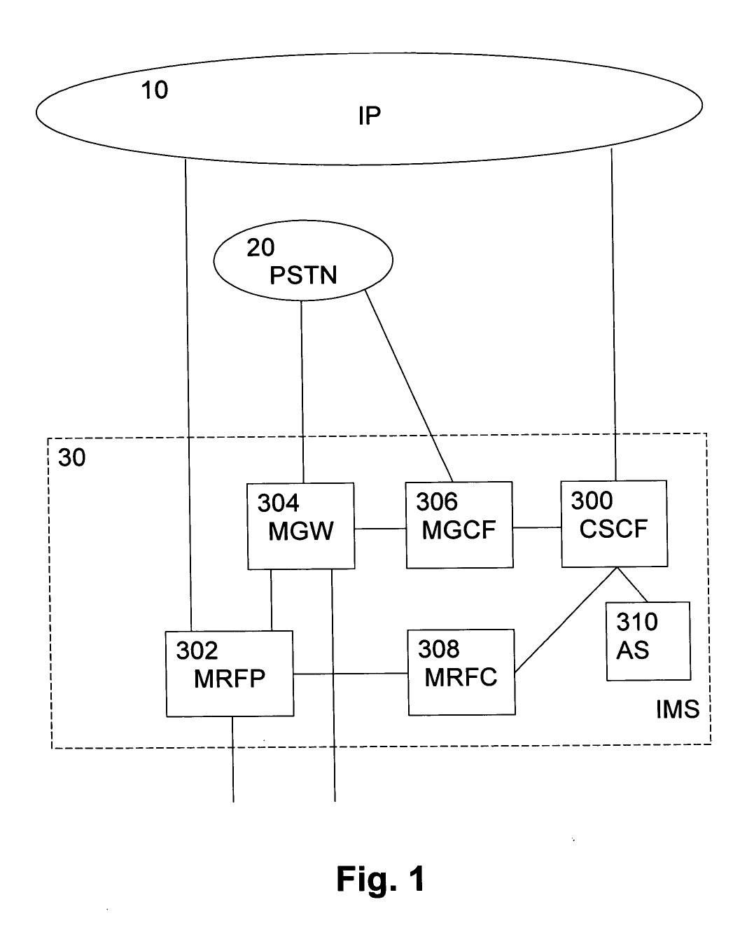

The preferred embodiment will now be described on the basis of an IMS-based network architecture as indicated in FIG. 1.

FIG. 1 shows a network architecture supporting multimedia sessions and comprising an IMS 30. It is noted that only those parts needed to understand the present invention are shown in FIG. 1. In the IMS 30, SIP is used between a user equipment (UE, not shown), which is the 3G terminology used for designating a terminal device, and a Call Session Control Function (CSCF), between a Media Gateway Control Function (MGCF) 306 and the CSCF 300, and among various CSCFs. The main elements of the IMS 30 are the CSCFs 300. The different types of CSCF comprise a Proxy CSCF (PCSCF) which is a SIP proxy server that performs the routing of the requests and responses of a UE towards an appropriate Interrogating-CSCF (I-CSCF), a Serving-CSCF (S-CSCF) which is the serving SIP proxy server that allows the user to access the services provided by the operator, and the I-CSCF which takes care of querying a Home Subscriber Server (HSS) in order to obtain the address of the S-CSCF to which the request must be forwarded. IMS network 30 further comprises application servers 310 (AS) which are accessed via CSCFs 300.

The MGCF 306 interacts with the CSCF 300 to perform control functions for a Media Gateway (MGW) 304 which is a gateway for the information flows that come from CS networks. Furthermore, the IMS 30 comprises a Multimedia Resource Function (MRF) which takes care of performing all necessary functions in order to be able to carry out multiparty calls and audio-video conferences on the Internet Protocol (IP). In particular, the MRF is divided, from a functional point of view, into a Multimedia Resource Function Controller (MRFC) 308 and a Multimedia Resource Function Processor (MRFP) 302. The MRFC 308 controls the media streams in the MRFP 302, interprets the information that arrives from the CSCF 300 or from an application server 310 which is a software application providing information required by a remote or local application, and performs the control of the users belonging to different audio-video conferences. The MRFP 302 provides the resources that must be controlled by the MRFC 308, mixes and processes the media streams and interacts with the MRFC 308 in order to update the list of active users in the transmission of real-time data.

In the example of FIG. 1, the MGW 304 and the MGCF 306 are connected to a CS network, e.g. a Public Switched Telephone Network (PSTN) 20, and the CSCF 300 and the MRFP 302 are connected to an IP network 10, e.g., the Internet. The open connection ends at the lower end of FIG. 1 may be connected to an access network via respective gateway devices.

Conferencing with the IMS 30 can be coordinated by the CSCF 300 in conjunction with an application server. The mixing of the various conference participants' media streams is then performed by the MRFP 302 based on the control of the MRFC 308 using e.g. H.248/MEGACO signaling in order to establish suitable IP bearers and, if required, SS7 bearers to support the mixed media streams. In this process, the MRFC 308 controls the media streams established by the MRFP 302 based on information supplied by the CSCF 300 and the relevant application server. The H.248 signaling is passed to the MRFP 302 across an Mp interface from the MRFC 308. Further details concerning the IMS 30 are described in the 3GPP specification TS 23.228.

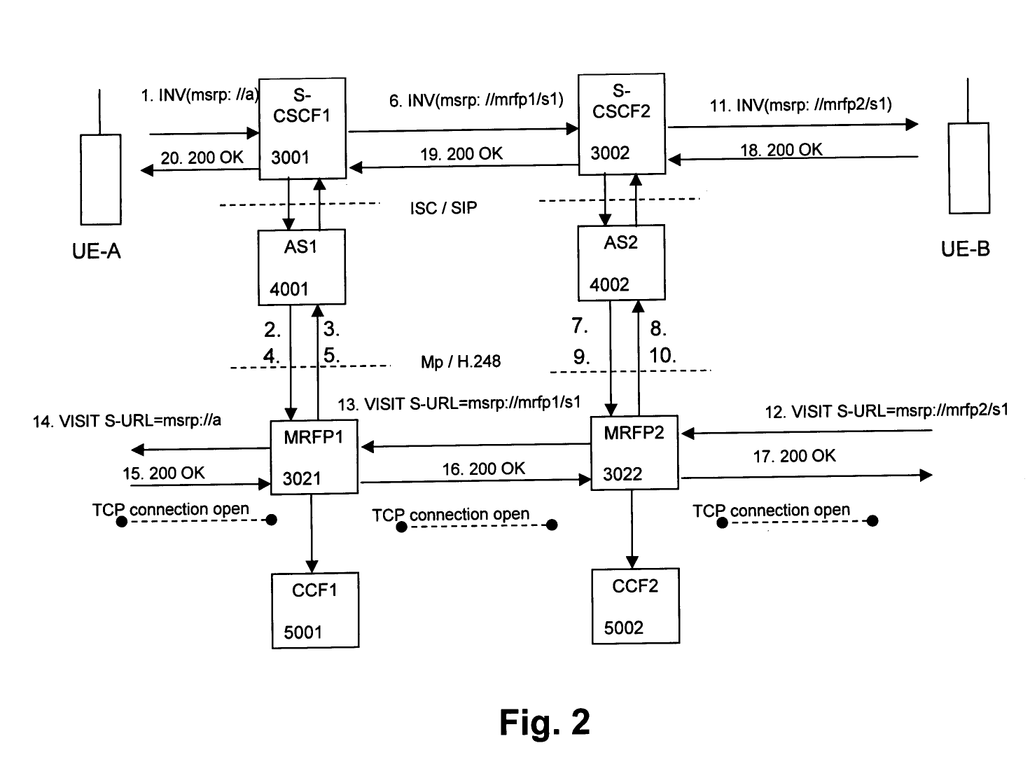

FIG. 2 shows a schematic block diagram and signaling scheme for providing a session inspection function according to the preferred embodiment. In the particular example of FIG. 2, the signaling is related to a charging function for charging chat sessions based on message details, such as content type, size, number of messages and the like. To achieve this, originating and terminating networks should be able to charge the chat sessions independently from each other. Therefore, two separate charging collection functions CCF1 5001 and CCF2 5002 are provided in the architecture of FIG. 2. In particular, respective first and second MRFPs 3021 and 3022 report accounting information to the CCFs 5001 and 5002 for offline charging. The CCFs 5001 and 5002 use this information to construct and format Call Detail Records (CDRs). Alternatively, the MRFPs 3021 and 3022 may report the accounting information to the MRFCs (not shown in FIG. 2) which then report it to the CCFs 5001 and 5002. The CDRs are database record units used to create billing records, for example, to enable correct end customer billing. A CDR contains details such as the called and calling parties, originating switch, terminating switch, call length, time of the day, information about the content transferred during the session (amount of RTP packets or messages, content types in each message, size of each content type) etc. These records may be passed to a charging gateway function for consolidation prior to being passed to the billing platform.

In order to provide this information to the CCFs 5001 and 5002, an entity must be used which understands MSRP which is the mechanism for transmitting a series of instant messages within a chat session. MSRP sessions are managed using the Session Description Protocol (SDP) offer/answer model carried by SIP. Due to the provision of multiparty chat sessions, the MRFPs 3021 and 3022 are able to understand MSRP. Therefore, it is proposed to use the MRFP for generating charging data or otherwise inspecting chat sessions or other sessions. The provision of an MRFP in the user plane part is optional, and the network operator can make this decision based on the need of charging. To achieve this, the operator may force the user plane to the MRFP by setting initial filter criteria or other control parameters to route the session set-up message, e.g. the SIP INVITE, to a respective application server colocated at the respective MRFC or comprising the respective MRFC functionality.

As indicated in FIG. 2, both originating and terminating networks may have their MRFP in the user plane path, and the respective MRFPs 3021 and 3022 both have interfaces to the respective CCFs 5001 and 5002. The controlling application servers AS1 4001 and AS2 4002 act as Back-To-Back User Agents (B2BUA) and the co-located or comprised MRFC functionality controls the respective MRFPs 3021 and 3022. A B2BUA entity is a SIP-based logical entity which can receive and process SIP INVITE messages as a SIP User Agent Server. It can also act as a SIP User Agent Client which determines how the request should be answered and how to initiate outbound calls. Unlike a SIP proxy server, the B2BUA maintains complete call state and participates in all call requests.

The use of H.248 signaling between the MRFCs located in the application servers 4001 and 4002 and the respective MRFPs 3021 and 3022 is not mandatory. Any other suitable signaling protocol can be used. The MRFPs and the application servers with the MRFC functionality may be co-located as well. The proposed solution can be applied irrespective of the fact whether they are co-located or not.

The preferred embodiment provides the advantage that MSRP relays are not needed, due to the fact that the MRFPs 3021 and 3022 can bind incoming and outgoing streams together using a context identity (ID) and a termination identity (ID) in H.248 and the MSRP address (MSRP URL). In particular, the MRFPs 3021 and 3022 generate the MSRP URL, a certain context identification and termination identification and knows to assign the stream that is received at this URL to the right context and termination identity. If other medias than messages are used in the same session, separate contexts may be reserved from the MRFPs 3021 and 3022 for each and every media. The contexts may be located in different physical entities.

To provide a connection between the two terminal devices UE-A and UE-B shown in FIG. 2, each of the MRFPs 3021 and 3022 needs to generate two termination IDs for the incoming and outgoing streams, respectively, and a context ID for the connection of the incoming and outgoing streams. This framework can be used to charge, log, filter or otherwise inspect any media, like chat, gaming or application sharing data, as long as the MRFPs 3021 and 3022 are used to carry this kind of data.

Consequently, no new H.248 packages are needed. If a new H.248 package is defined, the corresponding event can be used to send a notification to the respective application servers 4001 and 4002 in response to the receipt of an MSRP SEND message. In this case, the application servers 4001 and 4002 can generate the CDRs and the MRFPs 3021 and 3022 do not need to have an interface to the CCFs 5001 and 5002, respectively.

In the following, the signaling steps of FIG. 2 are described in more detail with reference to the indicated step numbers.

In step 1, the UE-A sends a SIP INVITE with SDP offer towards the UE-B. The SDP contains a globally routable MSRP URL (msrp://a) of the UE-A. The INVITE request is routed to an originating S-CSCF1 3001 which checks the initial filter criteria and based on the checking result routes the INVITE request to the application server AS1 4001. Then, the MRFC functionality at the AS1 4001 reserves a context and termination from the MRFP1 3021. The corresponding H.248 request contains the SDP offer as remote descriptor of the termination. Furthermore, the local descriptor is set to “Choose” (“$”), which means that the MRFP 3021 should freely reserve it. Hence, the H.248 request may look as follows:
Add.req (context ID=$, term ID=$, Remote descriptor: SDP: msrp://a, Local Descriptor=$)

In step 3, the MRFP1 3021 returns the context ID and termination ID, and the reserved local descriptor (SDP) for terminal side termination. This SDP is not used in the AS1 4001, but included here in order to have common procedures for both termination reservations. The respective H.248 reply may look as follows:
Add.reply (context ID=C1, Term ID=T1, Local descriptor=msrp://mrfp1/s0)

In step 4, the MRFC functionality at the AS1 4001 reserves another termination from the same context. The local descriptor is set to “Choose” (“$”), which means that the MRFP1 3021 should again reserve it. The corresponding H.248 request may look as follows:
Add.req (context ID=C1, term ID=$, Local descriptor=$)

In step 5, the MRFP1 3021 returns the reserved local descriptor (SDP) for network side termination. The SDP contains a dynamic MSRP URL. The MSRP URL contains a unique Session ID which can be used to address this particular session in the MRFP1 3021. The corresponding H.248 reply may look as follows:
Add.reply (context ID=C1, Term ID=T2, Local descriptor=msrp://mrfp1/s1)

The AS1 4001 then sends a new SIP INVITE to the S-CSCF1 3001, which contains the SDP returned in the previous step.

In step 6, the S-CSCF1 3001 forwards the INVITE request to the terminating network, where it is routed to a terminating S-CSCF2 3002 which checks the initial filter criteria and based on the checking result it routes the INVITE request to a second application server (AS2) 4002.

In step 7, MRFC functionality at the AS2 4002 reserves a context and termination from the MRFP2 3022 at the terminating network. The corresponding request contains the SDP offer as remote descriptor of the termination. The local descriptor is set to “Choose” (“$”) which means that the MRFP2 3022 should freely reserve it. This H.248 request may look as follows:
Add.req (context ID=$, term ID=$, Remote descriptor: SDP; msrp://mrfp1/s1, Local Descriptor=$)

In step 8, the MRFP2 3022 returns the context ID and termination ID, and the reserved local descriptor (SDP) for network side termination. This SDP is not used in the AS2 4002, but included here in order to have common procedures for both termination reservations. The corresponding H.248 reply may look as follows:
Add.reply (context ID=C1, Term ID=T1, Local descriptor=msrp://mrfp2/s0)

In step 9, the MRFC functionality at the AS2 4002 reserves another termination from the same context. The local descriptor is set to “Choose” (“$”), which means that the MRFP2 3022 should freely reserve it. The corresponding H.248 request may look as follows:
Add.req (context ID=C1, term ID=$, Local descriptor=$)

In step 10, the MRFP2 3022 returns the reserved local descriptor (SDP) for terminal side termination. The SDP contains a dynamic MSRP URL. The MSRP URL contains a unique Session ID which can be used to address this particular session in the MRFP2 3022. The corresponding H.248 reply may look as follows:
Add.reply (context ID=C1, Term ID=T2, Local descriptor=msrp://mrfp2/s1)

In step 11, the AS2 4002 sends a new SIP INVITE via the S-CSCF2 3002 towards the UE-B. The INVITE contains the SDP returned in the previous step. The UE-B acknowledges the INVITE with a SIP 183 ‘session progress’ (not shown) which contains an SDP answer. The SDP indicates to the UE-A that the UE-B is accepting the MSRP invitation. The UE-A acknowledges the SIP 183 ‘session progress’ with a PRACK. The UE-B acknowledges the PRACK with a SIP 200 ‘OK’. Both sides open a PDP context for media. Thereafter, the UE-A sends an UPDATE to the UE-B. The UE-B acknowledges the UPDATE with a 200 ‘OK’. This signaling of step 11 correspond to the 3GPP specification TS24.229 and is not shown in FIG. 2.

In step 12, the UE-B sends an MSRP VISIT to the MSRP URL it received in the SDP of the INVITE. If the address (MSRP URL) is a Fully Qualified Domain Name (FQDN), the UE-B initiates a DNS (Domain Name Server) query to retrieve the destination IP address. Correspondingly, the MRFP2 3022 receives the VISIT which contains the S-URL and session ID which the MRFP2 3022 at the terminating network side has generated, and is now able to find the context ID and termination ID based on that information.

In step 13, the MRFP 3022 at the terminating network side finds the context ID and the other termination in the context. It finds the remote descriptor of that termination (SDP), and modifies the S-URL in the VISIT to contain the URL from the SDP. Then, it sends the modified VISIT to the address in the S-URL. The MRFP1 3021 receives the VISIT which contains the S-URL and session ID the MRFP 3021 at the originating network side has generated, and is now able to find the context ID and termination ID based on that information.

In step 14, the MRFP 3021 at the originating network side finds the context ID and the other termination in the context at the terminal side. It finds the remote descriptor of that termination (SDP), and modifies the S-URL in the VISIT to contain the URL from the SDP. Then, it sends the modified VISIT to the address in the S-URL. The UE-A receives the VISIT.

In step 15, once the VISIT has been sent through the user plane path, a TCP (Transmission Control Protocol) connection is opened in a hop-by-hop manner, and any information can be sent through this TCP connection. The UE-A acknowledges the VISIT by sending a SIP 200 OK to the TCP connection. In step 16, the MRFP1 3021 forwards the 200 OK to the MRFP2 3022. Then, in step 17, the UE-B receives the 200 OK and sends a 200 OK towards to the UE-A in step 18. The S-CSCF2 3002 sends the 200 OK towards the SCSCF1 3001 via the AS2 4002 (step 19). In step 20, the S-CSCF1 3001 sends the 200 OK towards the UE-A via the AS 1 4001.

At this point, the session is active and both parties can start sending MSRP SEND messages over the TCP connection. The MRFP1 3021 and the MRFP2 3022 in the routing path can interpret the content of the SEND messages and generate CDRs based thereon. Alternatively, the MRFP1 3021 and the MRFP2 3022 can send an event to the respective AS1 4001 and AS2 4002 in response to the reception of a SEND message, and the AS1 4001 and the AS2 4002 can generate the CDRs.

If it is required that network operators do content filtering based on context types, such a content filtering can be achieved in the following two ways. First, the SDP for the MSRPs 3021 and 3022 contains an Accept-Types attribute that tells to the receiver what MIME (Multipurpose Internet Mail Extension) content types the sender is accepting in the session. Once the session is initialized, the respective MRFP composes the SDP that is sent to the next hop. The co-located MRFC can limit the allowed content types by removing the types from the Accept-Types attribute, before it is sent out. For example, if the SDP from the UE-A contains content types X, Y and Z, the respective MRFC can remove the type Z before the SDP is sent to the UE-B. As a second option, the MRFPs 3021, 3022 in the user plane path can interpret the content types in the SEND message and remove types that are not allowed. It is noted that both ways indicated above may as well be implemented together.

As described above, a new way of charging chat sessions or other sessions is proposed, which does not require any new dedicated entities or procedures. The charging operation may be performed per individual actions in the sessions, as described above, or charging may be performed per session as up to the present.

It is noted that the present invention is not restricted to the above described embodiment, but can be used for any kind of inspection of sessions in packet data networks where the respective session data can be routed via a media resource functionality. In particular, the present invention is not restricted to the specific signaling messages described in connection with FIG. 2, and any corresponding signaling messages of other protocols having similar functionalities can be used. The preferred embodiment may thus vary within the scope of the attached claims.

1. A method of inspecting a session in a packet data network, said method comprising the steps of:
a) selectively routing a set-up message of a session to a predetermined server node of a packet data network;
b) processing said set-up message at said server node; and
c) controlling a media resource function of said packet data network based on said processing step, so as to bind incoming and outgoing data streams in order to relay said session via said media resource function.

2. A method according to claim 1, wherein said routing step is performed in response to a filter criteria set for an inspection.

3. A method according to claim 1, wherein said session is an instant messaging session according to a Message Session Relay Protocol.

4. A method according to claim 3, wherein said binding is performed using at least one of a context identity, a session identity, a termination identity and an address of said Message Session Relay Protocol.

5. A method according to claim 4, further comprising the step of returning an address information which contains said session identity from said media resource function to said predetermined server node.

6. A method according to claim 5, wherein the step of returning the address information comprises returning the address information in a reserved local descriptor for terminal side termination.

7. A method according to claims 5, further comprising the steps of forwarding said address information from said predetermined server node to a terminating network side in a session invitation message, and using said address information at said terminating network side to address said media resource function.

8. A method according to claim 1, wherein said set-up message is an INVITE method of a Session Initiation Protocol.

9. A method according to claim 1, further comprising the step of generating a charging record for said relayed session or for at least one event that occurred in said session at said media resource function.

10. A method according to claim 9, wherein the step of generating a charging record comprises including information in said charging record about at least one of content type of a message, a size of a message and an amount of transmitted messages within said session.

11. A method according to claim 9, further comprising the step of providing an interface between said media resource function and a charging collection function to generate charging data for said relayed session.

12. A method according to claim 9, further comprising the step of notifying said server node of a receipt of a predetermined message of said session, and generating the charging record at said server node based on said notification.

13. A method according to claim 1, wherein said controlling step is performed using a H.248 signaling.

14. A method according to claim 1, wherein said controlling step comprises reserving a context and a termination at said media resource function, and offering a remote descriptor of said termination.

15. A method according to claim 1, wherein said controlling step comprises setting a local descriptor to a value indicating that it can be selected by a media resource function processor.

16. A method according to claim 1, further comprising the step of limiting at least one of permitted content types, a size of messages or a total amount of messages of said session at said media resource function.

17. A method according to claim 16, further comprising the step of discarding messages at said media resource function based on said limiting step.

18. A method according to claim 16, wherein said limiting step is performed at said server node.

19. A system for inspecting a session in a packet data network, said system comprising:
a) routing means for selectively routing a set-up message of a session to a predetermined server node of a packet data network, said server node being configured to process said set-up message; and
b) media resource function means for binding incoming and outgoing data streams in order to relay said session via said media resource function means, said media resource function means being controlled by said server node based on said processing of said set-up message.

20. A system according to claim 19, wherein said routing means comprises a Call Session Control Function of an Internet Protocol Multimedia Subsystem.

21. A system according to claim 19, wherein said routing means is configured to perform said selective routing in response to predetermined filter criteria.

22. A system according to claim 19, wherein said media resource function means comprises a Media Resource Function Processor of an Internet Protocol Multimedia Subsystem.

23. A system according to claim 19, wherein said media resource function means comprises an interface to a charging collection function.

24. A system according to claim 19, wherein said server node is an application server for providing application-related information.

25. An application server for providing information required by a remote or local application of a packet data network, said application server being configured to receive and process a set-up message of a session of said packet data network, and to control a media resource function of said packet data network to bind incoming and outgoing data streams in order to inspect said session at said media resource function.

26. A media resource function processor node for establishing data bearers to support mixed media streams, said processor node being configured to bind incoming and outgoing data streams in order to relay sessions via said processor node in response to a control signaling, and to initiate an inspection of said session.
